(19) United States
(12) Patent Application Publication
(10) Pub. No.: US 2026/0231869 A1
(43) Pub. Date: Aug. 13, 2026

(54) SPILL TRAYS

(71) Applicant: Zeba Parkar, Roswell, GA (US)

(72) Inventor: Zeba Parkar, Roswell, GA (US)

(21) Appl. No.: 19/452,347

(22) Filed: Jan. 18, 2026

Related U.S. Application Data
(60) Provisional application No. 63/747,002, filed on Jan. 18, 2025.

(51) Int. Cl. A01G 9/04; B33Y 80/00

(52) U.S. Cl. CPC A01G 9/04; B33Y 80/00

(57) ABSTRACT

A spill tray for supporting a plant container may include a tray body defining a surface. The spill tray may further include a tray rim extending from the surface and defining a spill retention volume with the tray body. The spill tray may further include at least one baffle extending from the surface at least partially into the spill retention volume. The at least one baffle is configured to contact the plant container. The at least one baffle includes a primary baffle, and a plurality of secondary baffles extending laterally from the primary baffle.

### CROSS REFERENCE TO RELATED APPLICATIONS

This application claims the benefit of Provisional Application No. 63/747,002, filed Jan. 18, 2025, the disclosure of which is incorporated by reference herein in its entirety.

### TECHNICAL FIELD

The application relates to spill trays, for example, spill trays for retaining spills from a container.

### BACKGROUND

Some containers may include fluids, for example water. Such containers may spill fluids when moved or jostled. Spilled fluids may affect surfaces under the containers.

### SUMMARY

Spill trays according to the disclosure retain spills, and are stronger than conventional spill trays. For example, conventional spill trays may be flimsy and flex along a base of the spill tray. Conventional trays often lack the structural integrity to support heavy, water-saturated plant containers, leading to base-flexing which can cause uneven drainage and localized stagnant water pools, promoting anaerobic conditions harmful to plant roots.

When a container is placed on the conventional spill tray, the tray may deform, reducing stability. This deformation often occurs due to a lack of flexural rigidity in the base, which the present disclosure addresses through a reinforced baffle network that increases the area moment of inertia of the tray body. Because the tray is flat, a fluid spilling from the container in the spill tray may initially be retained, but may slosh or slide away and fall away from the spill tray.

In some examples, a spill tray for supporting a plant container may include a tray body defining a surface. The spill tray may further include a tray rim extending from the surface and defining a spill retention volume with the tray body. The spill tray may further include at least one baffle extending from the surface at least partially into the spill retention volume. The at least one baffle is configured to contact the plant container. The at least one baffle includes a primary baffle, and a plurality of secondary baffles extending laterally from the primary baffle.

The at least one baffle strengthens the tray body and may reduce flexing of the tray body. For example, the intersecting relationship between the primary and secondary baffles creates a structural truss-like effect across the surface. The at least one baffle may act as a fluid dampeners to break up surface tension and kinetic energy of sloshing fluids. At the same time, the at least one baffle may reduce sloshing or sideways movement of fluid in the spill tray, helping the fluid be retained in the spill tray. Additionally, the baffle may lift the container above the surface of the tray body, which may reduce microbial growth. In containers that are used to grow plants, lifting the container above the surface reduces contact with fluid, which reduces root rot and diseases. For example, the at least one baffle may also define a standoff distance between the container and the surface, providing an air gap that facilitates gas exchange at the container's drainage holes, thereby reducing root rot and diseases associated with stagnant water contact.

Various aspects and advantages of examples of the disclosure have been summarized. The above Summary is not intended to describe each example or every implementation of the examples of the present disclosure. The Drawings and the Detailed Description that follow more particularly exemplify certain examples.

### BRIEF DESCRIPTION OF THE DRAWINGS

The disclosure may be more completely understood in consideration of the following detailed description of various examples in connection with the accompanying figures.

FIG. 1A is a perspective view of an example spill tray including a tray body, a tray rim, and at least one baffle.

FIG. 1B is a side view of the spill tray of FIG. 1A.

FIG. 2 is a perspective view of an example spill tray including a primary baffle discontinuous from secondary baffles.

FIG. 3 is a perspective view of an example spill tray including a primary baffle and angled secondary baffles.

FIG. 4 is a perspective view of an example spill tray including a tapering baffle and an auxiliary baffle.

FIG. 5 is a perspective view of an example spill tray including baffles arranged along a circumference.

FIG. 6 is a perspective view of an example spill tray including undulating baffles.

FIG. 7A is a perspective view of an example spill tray including an undulating rim, tapered baffles, and ring baffles.

FIG. 7B is a front view of the spill tray of FIG. 7A.

FIG. 7C is a rear view of the spill tray of FIG. 7A.

### DETAILED DESCRIPTION

Containers such as food or beverage containers, medical containers, or plant containers or pots may have water. The water may spill. Spill trays may be placed below such containers to catch spills. Spill trays may be made of materials that have some flex, for example plastic. Because of the flexing and weight of the container, spill trays may bend and deform, and spill retained water.

The present disclosure describes spill trays that retain spills. In some examples, a spill tray may include a tray body defining a surface. The spill tray may further include a tray rim extending vertically from the surface and defining a spill retention volume with the tray body. The spill tray may further include at least one baffle extending from the surface at least partially into the spill retention volume. The at least one baffle strengthens the tray body and may reduce flexing of the tray body. At the same time, the at least one baffle may reduce sloshing or sideways movement of fluid in the spill tray, helping the fluid be retained in the spill tray.

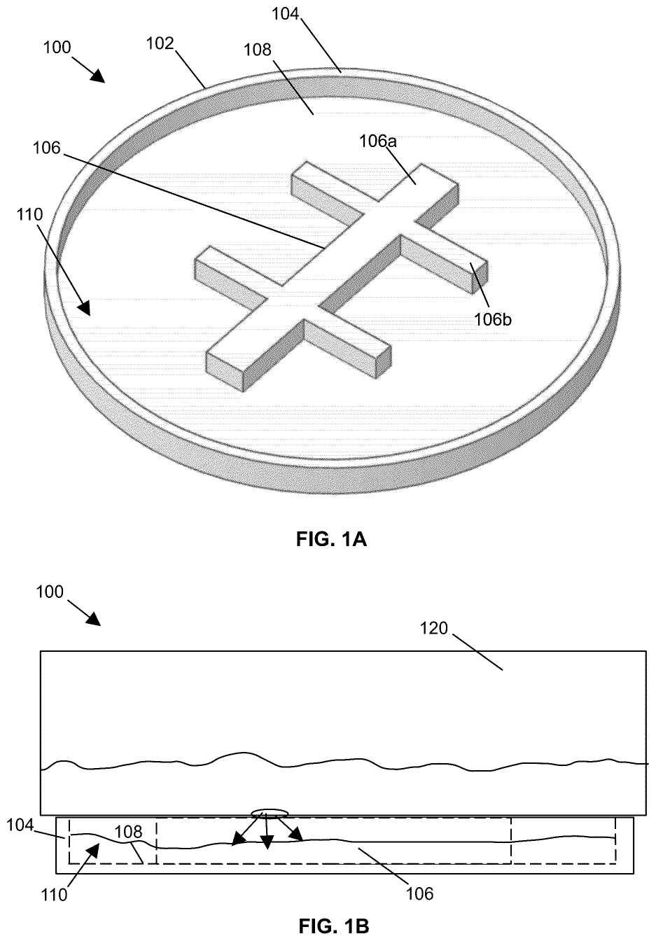

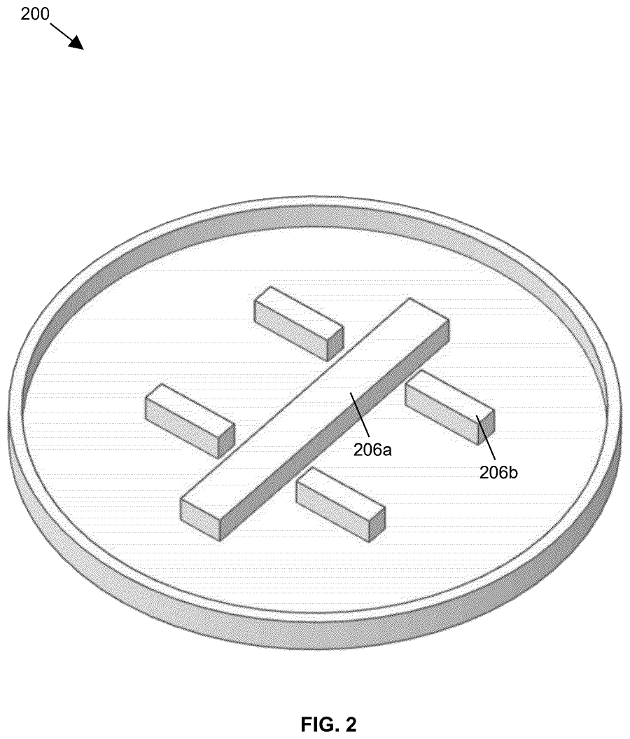

FIG. 1A is a perspective view of an example spill tray 100 including a tray body 102, a tray rim 104, and at least one baffle 106. FIG. 1B is a side view of spill tray 100 of FIG. 1A.

Tray body 102 defines a surface 108. Tray rim 104 extends from surface 108 and defines a spill retention volume 110 with tray body 102. Tray rim 104 may extend vertically (for example, at a right angle) or in an angled manner. At least one baffle 106 extends from surface 108 at least partially into spill retention volume 110. In some examples, tray rim 104 and surface 108 may be made of a monolithic, unitary construction to ensure a leak-proof fluid retention volume 110.

Surface 108 of tray body 102 may be flat. In some examples, surface 108 may be contoured or textured.

Spill tray 100 may include any suitable material. For example, spill tray 100 may include one or more of a plastic, a glass, a wood, a metal, an alloy, a paper, a ceramic, or a composite. In some examples, spill tray 100 includes or consists of plastic. The plastic may include one or more of a polyolefin, a polyester, a polyamide, a polylactic acid, a polyethylene terephthalate, a polycarbonate, or a elastomer. In some examples, spill tray 100 includes polylactic acid.

At least one baffle 106 may extend vertically from surface 108. In some examples, at least one baffle 106 includes at least two baffles, or more baffles. In some examples, each baffle is similar or different in size or shape, for example, length, height, width, contour, path, or size or any dimension.

In some examples, at least one baffle 106 includes a primary baffle 106a, and a plurality of secondary baffles 106b extending laterally from primary baffle 106a. The lateral extending may help provide support to a container 120 carried or supported on top of spill tray 100. The term “laterally” as used herein includes secondary baffles 106b extending at right angles, acute angles, or obtuse angles from the primary baffle 106a, as well as curved or branching paths. Additionally at least one baffle 106 structurally supports and strengthens tray body 102, for example a relatively thin bottom or flat portion of tray body 102 under surface 108. For example, by acting as stiffening ribs that distribute the localized downward force of the container 120 across a larger surface area of the tray body 102. When container 120 is placed on spill tray 100, water may spill or exit container 120 through an outlet (for example, a drain outlet of a plant container) into interior volume 110. At least one baffle 106 may reduce or stop or slow sloshing or moving of the water in interior volume 110, so that the water in interior volume 110 remains in interior volume 110 and does not spill out of spill tray 100.

The at least one baffle 106 is configured to provide contact points or contact surfaces with the base of the container 120, such that a portion (for example, a majority) of the surface area of the container base remains suspended and exposed to the air gap within the spill retention volume 110.

In some examples, at least one of the plurality of secondary baffles 106b extends continuously from primary baffle 106a, as shown in FIG. 1A. For example, primary baffles 106a and one or more secondary baffles 106b may be connected or formed or adhered or molded together.

The primary baffle 106a may be a structure (for example, a rib) extending across the tray body 102, while the secondary baffles 106b may act as transverse structural members that prevent the tray body from folding along the axis of the primary baffle.

There may be any number of primary baffle 106a and secondary baffle 106b, for example, one, two, or more. At least one secondary baffle 106b may be be smaller in one dimension (for example, a width or a length) compared to primary baffle 106a. In some examples, each secondary baffle 106b has a same height with each other. In some examples, each secondary baffle 106b has a same height with primary baffle 106a.

In some examples, a total number of the plurality of secondary baffles 106b is even. For example, secondary baffles 106b may be disposed symmetrically on both sides of primary baffle 106a. In other examples, the total number of the plurality of secondary baffles 106b is odd. For example, plurality of secondary baffles 106b may be staggered or interleaved.

In some examples, primary baffle 106a has a primary baffle length; each secondary baffle 106b has a respective secondary baffle length. In some examples, the primary baffle length is greater than the respective secondary baffle length of each secondary baffle 106b. In some examples, each secondary baffle 106b is identical in a secondary baffle width and a secondary baffle length. In other examples, each secondary baffle 106a differs in a secondary baffle width and a secondary baffle length.

In some examples, a height of the at least one baffle 106 is same as that of tray rim 104. In other examples, a height of the at least one baffle 106 is less than that of tray rim 104. In some examples, a height of at least one baffle 106 is more than that of tray rim 104. Spill tray 100 is configured to support container 120 on one or both of tray rim 104 or at least one baffle 106. For example, support container 120 may rest on some or all of at least one baffle 106 but without contacting tray rim 104 (being smaller than tray rim 104) or with contacting tray rim 104 (being larger than tray rim 104). In some examples, at least one baffle 106 is shorter than tray rim 104 and container 120 may be supported only on at least one baffle 106.

Tray rim 104 and tray body 102 may have any suitable shape, for example, circular, oval, polygonal, square, rounded polygonal, or any predetermined curve or contour. In some examples, tray rim 104 is undulating. Undulating tray rim 104 may be stronger to support weights of containers and may resist flexing of tray body 102 compared to non-undulating tray rim 104. The undulations provide a corrugated structural profile that resists hoop stress and prevents the rim from splaying outward under heavy loads.

Tray body 102, at least one baffle 106, and tray rim 104 may be formed together or separately and attached. In some examples, tray body 102, at least one baffle 106, and tray rim 104 are unitary (for example, formed by molding, stamping, machining, casting, or additive manufacturing). In some examples, one or both of tray rim 104 or at least one baffle 106 is adhered to tray body 102 for example, by adhesive or weld. In some examples, tray rim 104 is adhered to tray body 102.

Tray rim 104 may have any suitable constant or varying width along rim of tray body 102. At least one baffle 106 may have any suitable constant or varying width along surface 108. In some examples, a maximum width of tray rim 104 is less than a maximum width of at least one baffle 106. In some examples, a maximum width of tray rim 104 is less than a minimum width of at least one baffle 106.

FIG. 2 is a perspective view of an example spill tray 200 including a primary baffle 206a discontinuous from secondary baffles 206b. Spill tray 200 is generally similar to spill tray 100 except for the differences described. Primary baffle 206a may have any gap to be discontinuous from secondary baffles 206b. At least one of the plurality of secondary baffles 206b (one, more than one, less than all, or all) is discontinuous with primary baffle 206a.

At least one baffle 106 or 206a may define at least one gap, for example, along a length of at least one baffle 106 or 206a.

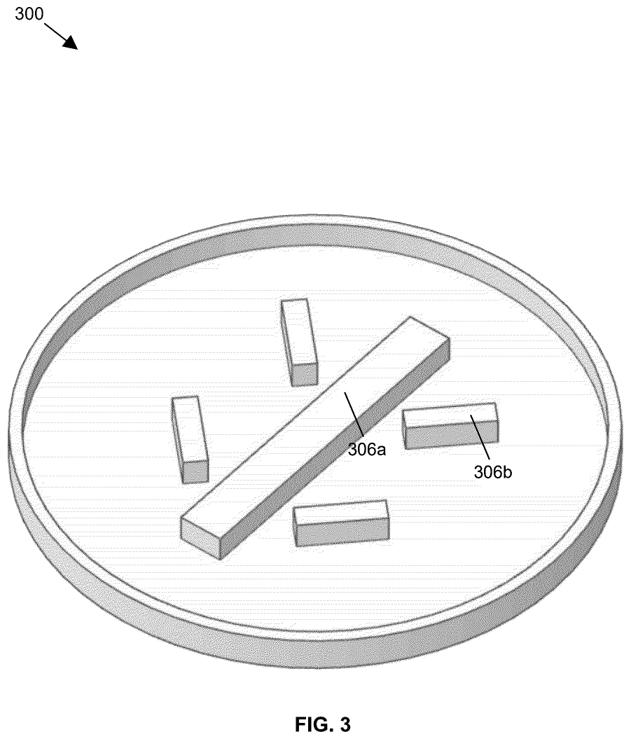

FIG. 3 is a perspective view of an example spill tray 300 including a primary baffle 306a and angled secondary baffles 306b. Spill tray 300 is generally similar to spill tray 200 except for the differences described. Secondary baffles 306b may be angled at any suitable angle relative to primary baffle 306a along surface of spill tray 300. The angles may be the same or different for different secondary baffles 306b. Secondary baffles 306b may be radially angled (for example like a clock) or any other suitable pattern.

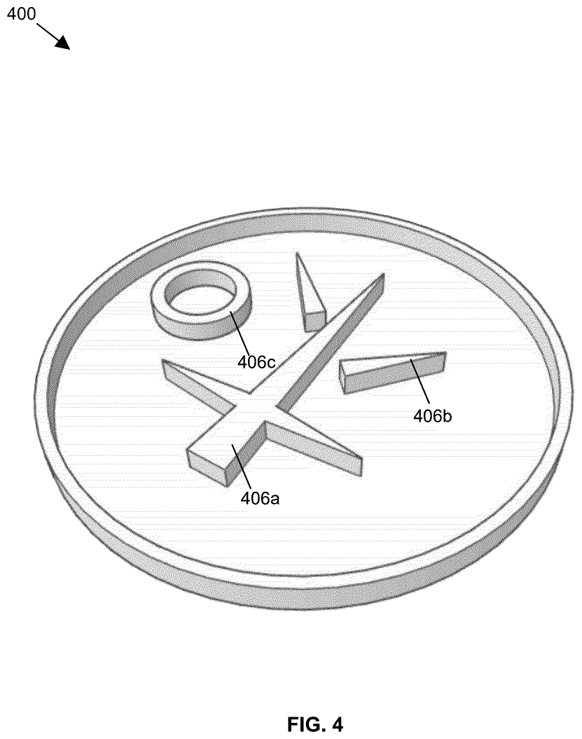

FIG. 4 is a perspective view of an example spill tray 400 including a tapering baffle 406a and an auxiliary baffle 406c. Spill tray 400 is generally similar to spill tray 100 except for the differences described. For example, primary baffle 406a tapers from a first end of primary baffle 406a to a second end of primary baffle 406a. In some examples, at least one secondary baffle 406b tapers in a direction away from primary baffle 406a. In some examples, each secondary baffle 406b tapers. The tapering of primary baffle 406a and secondary baffles 406b may create a self-centering geometry where the varying height or width of the baffles guides the container 120 toward a stable, central position within the tray 400.

Auxiliary baffle 406c may be distinct from primary baffle 406a and secondary baffles 406b and have any suitable shape and be positioned at one or more regions to provide additional support or water sloshing resistance. In some examples, auxiliary baffle 406c is at least one ring baffle. The ring baffle may be a regular or irregular generally or precisely circular, oval, or elliptical ring, or some polygonal or curved ring shape. The ring baffle may be closed (no gaps) or open (having at least one gap).

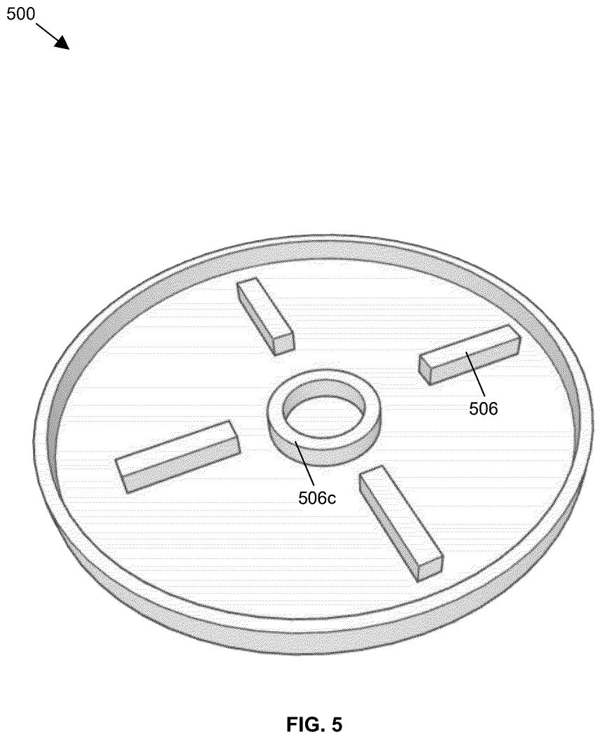

FIG. 5 is a perspective view of an example spill tray 500 including baffles 506 arranged along a circumference. Spill tray 500 is generally similar to spill tray 100 except for the differences described. For example, any number of 3, 4, 5, 6, or more baffles 506 may be arranged symmetrically or assymetrically along a circumference or about a center of spill tray 500. In some examples, an auxiliary baffle 506c may be positioned at or near the center of spill tray 500 in between baffles 506.

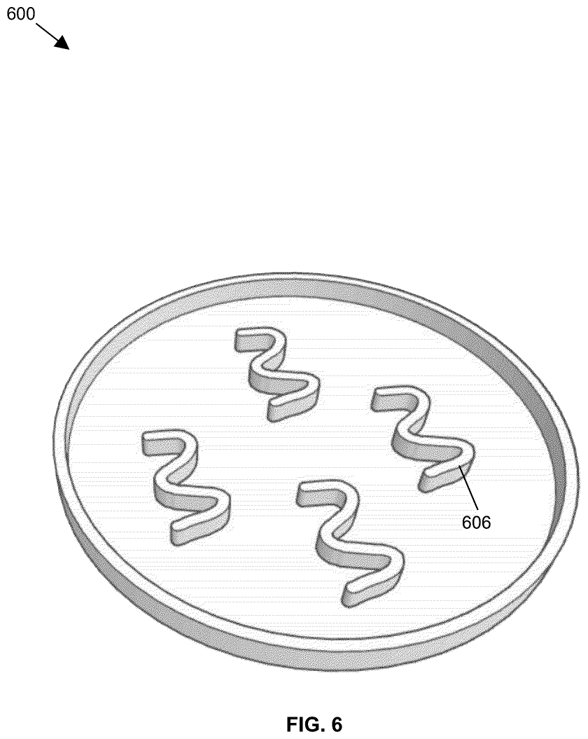

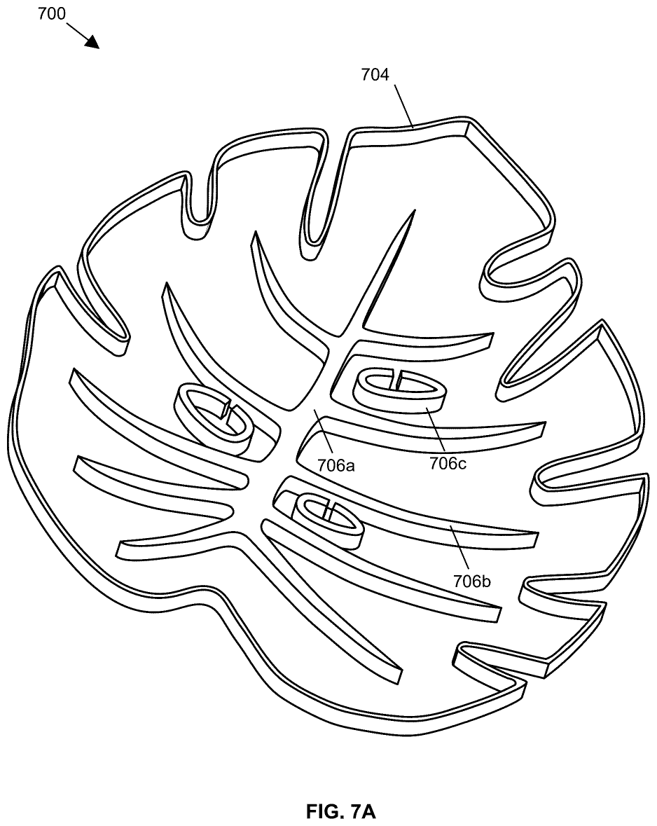

FIG. 6 is a perspective view of an example spill tray 600 including undulating baffles 606. Spill tray 600 is generally similar to spill tray 100 except for the differences described. Baffles 606 undulate along a length of each baffle. Undulating baffles 606 may be stronger than non-undulating baffles, and may resist water sloshing from different or varied directions and angles. The undulations may be smoothly curved or jagged or zig-zag. The undulations may be uniform or irregular, or even tapering from one end to another. The undulations may increase the total linear length of the baffle per unit of surface area, further increasing the rigidity of the base.

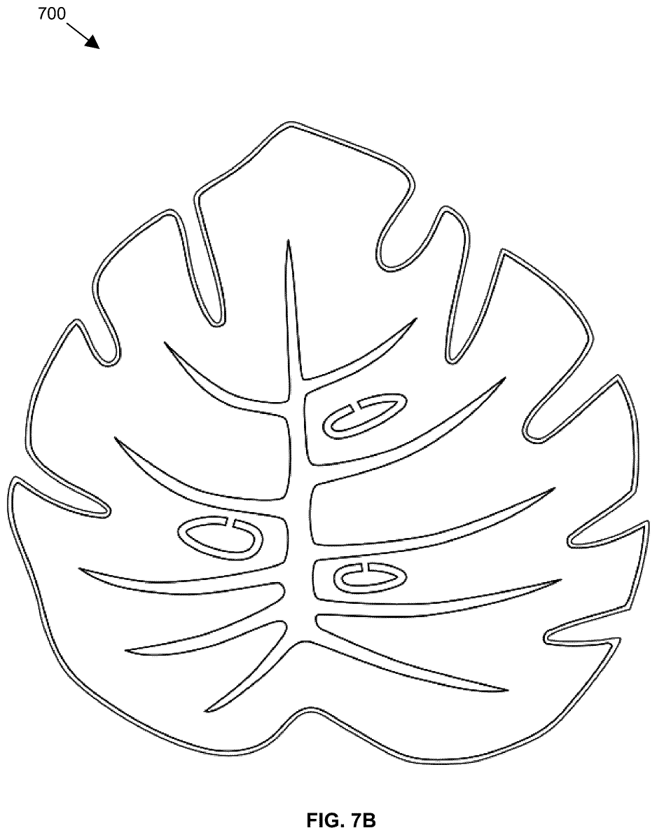

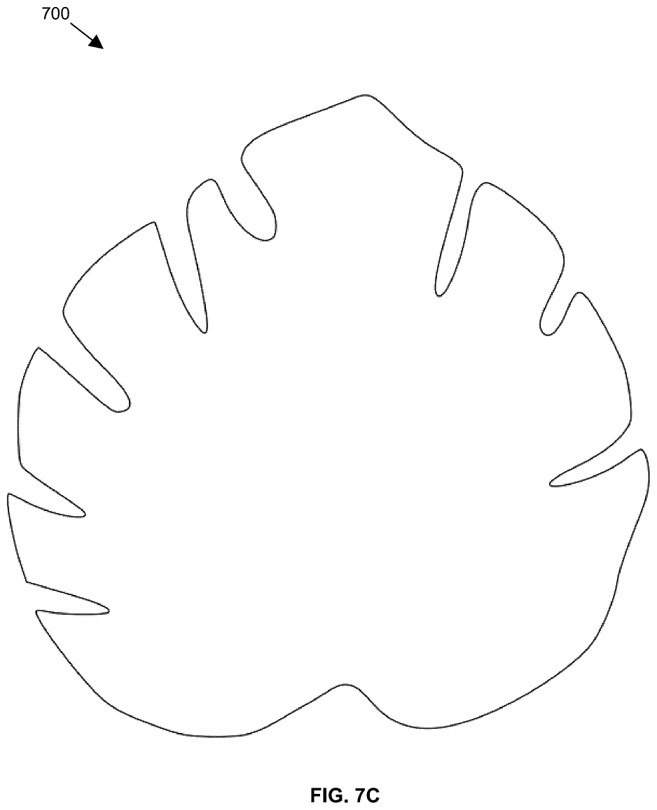

FIG. 7A is a perspective view of an example spill tray 700 including an undulating rim 704, tapered baffles 706a and 706b, and ring baffles 706c. FIG. 7B is a front view of spill tray 700 of FIG. 7A. FIG. 7C is a rear view of spill tray 700 of FIG. 7A. Spill tray 700 is generally similar to spill tray 100 except for the differences described. In some examples, at least one baffle of spill tray 700 includes primary baffle 706a and secondary baffles 706b each being tapered. In some examples, a single primary baffle 706a extends along a primary tray axis and ten secondary baffles 706b extend away from the single primary baffle 706a in a direction angled to the primary tray axis. At least one ring baffles 706c may have an oval shape, for example, an elongated oval shape. In some examples, at least one ring baffle 706c has a gap.

In some examples, at least one ring baffle 706c is interleaved with plurality of secondary baffles 706b. For example, a weight of a container may be distributed along primary baffle 706a, secondary baffles 706b, and ring baffles 706c at different portions of spill tray 700.

In some examples, primary baffle 706a and secondary baffles 706b together are shaped like veins. Such a configuration may further provide strength against flexing of spill tray 700, provide even support to a container, and resist sloshing or spillage of water.

In some examples, one or more of primary baffle 706a or secondary baffles 706b extends along a curved path. For example, a scimitar-like path.

In some examples, a periphery of the tray body of spill tray 700 defines a plurality of fenestrations. The fenestrations may be defined by (for example) follow undulations of tray rim 704. In some examples as shown in FIG. 7A, the plurality of fenestrations are interleaved with at least one baffle 706b. For example, as shown in FIG. 7A, gaps in the surface of the tray body may be present along the edge of the tray body (in the undulations). The fenestrations are surrounded by portions of the undulating rim 704. The fenestrations may be positioned along tray rim 704 to allow for air ingress toward the container's root system even when the lower spill retention volume 110 contains fluid.

Spill trays according to the present disclosure may be formed using any suitable technique. In some examples, a technique of forming a spill tray includes one or more of additive manufacturing, molding, thermoforming, casting, vacuum forming, or stamping.

The additive manufacturing may include fused deposition modeling. In additive manufacturing, such as fused deposition modeling, the baffles may be printed with a specific infill density or orientation—for example, a high-density rectilinear infill—that is different from the infill of the tray body to optimize the strength-to-weight ratio.

In some examples involving fused deposition modeling, the spill tray is formed by extruding a thermoplastic filament (e.g., polylactic acid, PETG, or any other suitable composition) through a heated nozzle to deposit material in a layer-by-layer fashion according to a predetermined toolpath. This additive process may be used to form the tray body 102, tray rim 104, and the at least one baffle 106 to be constructed as a single, continuous, and monolithic structure. Because the baffles are deposited as part of the same material stream as the surface 108, the interface between the baffles and the tray body may be characterized by fused polymer chains, providing superior resistance to delamination under the heavy vertical loads of a plant container compared to trays with separately attached components.

Furthermore, the fused deposition process may enable localized control over the internal geometry of the spill tray. For example, the at least one baffle 106 may be printed with a first infill density or a specific infill pattern—such as a rectilinear, honeycomb, or gyroid pattern—that provides high compressive strength, while the tray body 102 may be printed with a second, lower infill density to reduce material consumption and weight. Additionally, the number of perimeters or shells defining the walls of the tray rim 104 and the baffles 106 can be increased relative to the horizontal layers of the surface 108 to specifically enhance the flexural rigidity of the vertical structures, thereby further reducing the deflection under load.

The toolpath for the secondary baffles 106b may be specifically programmed to intersect or overlap with the toolpath of the primary baffle 106a, creating a reinforced structural node at each junction. By orienting the deposition layers such that the longitudinal axis of the polymer strands in the baffles aligns with the expected stress vectors from the container 120, the process may impart an engineered anisotropy to the spill tray. This structural alignment may cause the tray to be most rigid in the directions where it is most likely to experience flexing, providing a customized structural response that may be difficult to achieve with traditional injection molding or vacuum forming techniques.

The following clauses are described:

Clause 1: A spill tray including:
a tray body defining a surface;
a tray rim extending vertically from the surface and defining a spill retention volume with the tray body; and
at least one baffle extending from the surface at least partially into the spill retention volume.

Clause 2: The spill tray of clause 1, wherein the surface of the tray body is flat.

Clause 3: The spill tray of clauses 1 to 2, wherein the spill tray includes one or more of a plastic, a glass, a wood, a metal, an alloy, a paper, a ceramic, or a composite.

Clause 4: The spill tray of clause 3, wherein the plastic includes one or more of a polyolefin, a polyester, a polyamide, a polylactic acid, a polyethylene terephthalate, a polycarbonate, or a elastomer.

Clause 5: The spill tray of any of clauses 1 to 4, wherein at least one baffle includes at least two baffles.

Clause 6: The spill tray of any of clauses 1 to 5, wherein the baffle includes a primary baffle, and a plurality of secondary baffles extending laterally from the primary baffle.

Clause 7: The spill tray of any of clauses 1 to 6, wherein at least one of the plurality of secondary baffles extends continuously from the primary baffle.

Clause 8: The spill tray of any of clauses 1 to 7, wherein at least one of the plurality of secondary baffles is discontinuous with the primary baffle.

Clause 9: The spill tray of any of clauses 6 to 8, wherein a total number of the plurality of secondary baffles is even.

Clause 10: The spill tray of any of clauses 1 to 9, wherein the at least one baffle consists of a single primary baffle along a primary tray axis and ten secondary baffles extending away from the single primary baffle in a direction angled to the primary tray axis.

Clause 11: The spill tray of any of clauses 6 to 10, wherein the primary baffle has a primary baffle length; wherein each secondary baffle has a respective secondary baffle length, and wherein the primary baffle length is greater than the respective secondary baffle length of each secondary baffle.

Clause 12: The spill tray of any of clauses 6 to 11, wherein each secondary baffle is identical in a secondary baffle width and a secondary baffle length.

Clause 13: The spill tray of any of clauses 6 to 11, wherein each secondary baffle differs in a secondary baffle width and a secondary baffle length.

Clause 14: The spill tray of any of clauses 1 to 13, wherein the at least one baffle further includes at least one ring baffle.

Clause 15: The spill tray of clause 14, wherein the ring baffle has an oval shape.

Clause 16: The spill tray of any of clauses 14 or 15, wherein the ring baffle has a gap.

Clause 17: The spill tray of any of clauses 14 to 16, wherein the at least one ring baffle is interleaved with the plurality of the secondary baffles.

Clause 18: The spill tray of any of clauses 1 to 17, wherein the at least one baffle defines at least one gap.

Clause 19: The spill tray of any of clauses 6 to 18, wherein the primary and the secondary baffles together are shaped like veins.

Clause 20: The spill tray of any of clauses 6 to 19, wherein the primary baffle tapers from a first end of the primary baffle to a second end of the primary baffle.

Clause 21: The spill tray of any of clauses 6 to 20, wherein at least one secondary baffle tapers in a direction away from the primary baffle.

Clause 22: The spill tray of clause 21, wherein each secondary baffle tapers.

Clause 23: The spill tray of any of clauses 6 to 22, wherein the secondary baffle extends along a curved path.

Clause 24: The spill tray of any of clauses 1 to 23, wherein the spill tray is configured to support a container on one or both of the tray rim or the at least one baffle.

Clause 25: The spill tray of any of clauses 1 to 24, wherein the tray rim is undulating.

Clause 26: The spill tray of any of clauses 1 to 25, wherein the tray body, the at least one baffle, and the tray rim are unitary.

Clause 27: The spill tray of any of clauses 1 to 26, wherein the at least one baffle is adhered to the tray body.

Clause 28: The spill tray of any of clauses 1 to 27, wherein the tray rim is adhered to the tray body.

Clause 29: The spill tray of any of clauses 1 to 28, wherein a periphery of the tray body defines a plurality of fenestrations.

Clause 30: The spill tray of clause 29, wherein the plurality of fenestrations are interleaved with the at least one baffle.

Clause 31: The spill tray of any of clauses 1 to 30, wherein a height of the at least one baffle is same as that of tray rim.

Clause 32: The spill tray of any of clauses 1 to 30, wherein a height of the at least one baffle is less than that of tray rim.

Clause 33: The spill tray of any of clauses 1 to 30, wherein a height of the at least one baffle is more than that of tray rim.

Clause 34: The spill tray of any of clauses 1 to 33, wherein a maximum width of the tray rim is less than a maximum width of the at least one baffle.

Clause 35: The spill tray of any of clauses 1 to 34, wherein a maximum width of the tray rim is less than a minimum width of the at least one baffle.

Clause 36: A method including forming the spill tray of any of clauses 1 to 35.

Clause 37: The method of clause 36, wherein forming of the spill tray includes one or more of additive manufacturing, molding, thermoforming, casting, vacuum forming, or stamping.

Clause 38: A spill tray for supporting a plant container, the spill tray including:
a tray body defining a surface;
a tray rim extending from the surface and defining a spill retention volume with the tray body; and
at least one baffle extending from the surface at least partially into the spill retention volume,
wherein the at least one baffle is configured to contact the plant container, and
wherein the at least one baffle includes a primary baffle, and a plurality of secondary baffles extending laterally from the primary baffle.

Clause 39: The spill tray of clause 38, wherein the tray rim is configured to contact the plant container.

Clause 40: The spill tray of clause 38 or 39, wherein the surface of the tray body is flat.

Clause 41: The spill tray of any of clauses 38 to 40, wherein the spill tray includes one or more of a plastic, a glass, a wood, a metal, an alloy, a paper, a ceramic, or a composite.

Clause 42: The spill tray of any of clauses 38 to 41, wherein at least one of the plurality of secondary baffles extends continuously from the primary baffle.

Clause 43: The spill tray of any of clauses 38 to 42, wherein the primary baffle has a primary baffle length; wherein each secondary baffle has a respective secondary baffle length, and wherein the primary baffle length is greater than the respective secondary baffle length of each secondary baffle.

Clause 44: The spill tray of any of clauses 38 to 43, wherein each secondary baffle differs in a secondary baffle width and a secondary baffle length.

Clause 45: The spill tray of any of clauses 38 to 44, wherein the at least one baffle further includes at least one ring baffle.

Clause 46: The spill tray of clause 45, wherein the ring baffle has an oval shape.

Clause 47: The spill tray of any of clause 45 or 46, wherein the at least one ring baffle is interleaved with the plurality of the secondary baffles.

Clause 48: The spill tray of any of clauses 38 to 47, wherein the primary baffle tapers from a first end of the primary baffle to a second end of the primary baffle, and wherein at least one secondary baffle tapers in a direction away from the primary baffle.

Clause 49: The spill tray of any of clauses 38 to 48, wherein the secondary baffle extends along a curved path.

Clause 50: The spill tray of any of clauses 38 to 49, wherein the tray body, the at least one baffle, and the tray rim are unitary.

Clause 51: The spill tray of any of clauses 38 to 50, wherein a height of the at least one baffle is same as that of the tray rim.

Clause 52: The spill tray of any of clauses 38 to 51, wherein the tray rim does not contact any of the at least one baffle.

Clause 53: The spill tray of any of clauses 38 to 52, wherein the tray rim extends vertically at a right angle from the surface.

Clause 54: The spill tray of any of clauses 38 to 53, wherein the at least one baffle extends vertically at a right angle from the surface.

Clause 55: A method including forming the spill tray of any of clauses 38 to 54.

Clause 56: The method of clause 55, wherein forming of the spill tray includes one or more of additive manufacturing, molding, thermoforming, casting, vacuum forming, or stamping.

Clause 57: The method of clause 55 or 56, wherein the additive manufacturing is fused deposition modeling.

Various examples have been described. These and other examples are within the scope of the following claims.

I claim:

1. A spill tray for supporting a plant container, the spill tray comprising:
a tray body defining a surface;
a tray rim extending from the surface and defining a spill retention volume with the tray body; and
at least one baffle extending from the surface at least partially into the spill retention volume,
wherein the at least one baffle is configured to contact the plant container, and
wherein the at least one baffle comprises a primary baffle, and a plurality of secondary baffles extending laterally from the primary baffle.

2. The spill tray of claim 1, wherein the tray rim is configured to contact the plant container.

3. The spill tray of claim 1, wherein the surface of the tray body is flat.

4. The spill tray of claim 1, wherein the spill tray comprises one or more of a plastic, a glass, a wood, a metal, an alloy, a paper, a ceramic, or a composite.

5. The spill tray of claim 1, wherein at least one of the plurality of secondary baffles extends continuously from the primary baffle.

6. The spill tray of claim 1, wherein the primary baffle has a primary baffle length; wherein each secondary baffle has a respective secondary baffle length, and wherein the primary baffle length is greater than the respective secondary baffle length of each secondary baffle.

7. The spill tray of claim 1, wherein each secondary baffle differs in a secondary baffle width and a secondary baffle length.

8. The spill tray of claim 1, wherein the at least one baffle further comprises at least one ring baffle.

9. The spill tray of claim 8, wherein the ring baffle has an oval shape.

10. The spill tray of claim 8, wherein the at least one ring baffle is interleaved with the plurality of the secondary baffles.

11. The spill tray of claim 1, wherein the primary baffle tapers from a first end of the primary baffle to a second end of the primary baffle, and
wherein at least one secondary baffle tapers in a direction away from the primary baffle.

12. The spill tray of claim 1, wherein the secondary baffle extends along a curved path.

13. The spill tray of claim 1, wherein the tray body, the at least one baffle, and the tray rim are unitary.

14. The spill tray of claim 1, wherein a height of the at least one baffle is same as that of the tray rim.

15. The spill tray of claim 1, wherein the tray rim does not contact any of the at least one baffle.

16. The spill tray of claim 1, wherein the tray rim extends vertically at a right angle from the surface.

17. The spill tray of claim 1, wherein the at least one baffle extends vertically at a right angle from the surface.

18. A method comprising forming the spill tray of claim 1.

19. The method of claim 18, wherein forming of the spill tray comprises one or more of additive manufacturing, molding, thermoforming, casting, vacuum forming, or stamping.

20. The method of claim 18, wherein the additive manufacturing is fused deposition modeling.
